(19) United States
(12) Patent Application Publication
(10) Pub. No.: US 2007/0088862 A1
(43) Pub. Date: Apr. 19, 2007

(54) Method and system for optimizing streaming media

(76) Inventors: Troy F. Burkman, Cedar Park, TX (US); Yen-Fu Chen, Austin, TX (US); Francis X. Kinstler, Cedar Park, TX (US)

Correspondence Address: IBM CORPORATION (RUS);c/o Rudolf O Siegesmund Gordon & Rees, LLp, 2100 Ross Avenue, Suite 2600, DALLAS, TX, 75201, US

(21) Appl. No.: 11/249,936

(22) Filed: Oct. 13, 2005

(51) Int. Cl. G06F 3/00

(52) U.S. Cl. 710/16

(57) ABSTRACT

The invention comprises a computer implemented process for optimizing a media environment having a media player and a data stream, the process comprising: configuring a performance criterion; receiving the data stream; collecting performance data from the data stream; analyzing the performance data to determine if the performance data satisfies the performance criterion; and if the performance data does not satisfy the performance criterion, identifying an alternate media environment that provides improved performance data, and changing to the alternate media environment for improved performance.

### FIELD OF THE INVENTION

The present invention relates generally to computer-to-computer data streaming and relates specifically to optimizing a media stream on a client computer attached to a network.

### BACKGROUND OF THE INVENTION

Streaming media allows users of the World Wide Web to watch or listen to live or previously recorded events. For example, users on a client computer can watch news or sporting events on a computer from anywhere in the world that has lnternet access. Businessmen can listen to their favorite local radio station when away on business and students can listen to their favorite rock bands while ignoring a boring lecture at school. Streaming media provides access to broadcasts in places where television and radio are not available.

Content providers broadcast streaming media in various formats. Standardized formats include MPEG, MP3, WAV and AVI, and proprietary formats include REALAUDIO, QUICKTIME, and WINDOWS MEDIA. Although most media players can play nearly all media file formats, some formats work best with a specific media player. Content providers often provide multiple media streams, giving users a choice of format.

Many factors such as data rates, video index quality, signal, connectivity, buffering and packet loss over the network and at the client computer affect the quality of a streaming media broadcast. Content providers often provide media streams at multiple quality levels, or data rates, to compensate for available download speeds. Download speed is affected by such things as the speed of the Internet connection used by the client, the available bandwidth on the client's local network and the available bandwidth at the sending server. Low data rates may provide, for example, “FM” quality audio while higher bit rates may provide “CD” quality audio. Lower data rates reduce susceptibility to packet loss, where parts of the streaming data are not delivered or become corrupted, which can interrupt the media stream. Users must make many choices when deciding which player, which stream type and which stream rate should be used to optimize the streaming media experience.

A program called BURSTWARE optimizes streaming media. BURSTWARE uses buffer management and advanced scheduling to provide an uninterrupted media stream. Buffering is a method of downloading the media content into the client computer memory before the media player needs the information to play the broadcast. Buffering allows missing packets to be replaced before they are needed. BURSTWARE uses the streaming bit rate information from the broadcasting server and the current bandwidth to calculate how much buffer is needed for a smooth broadcast, then schedules bursts of content based on available bandwidth.

As discussed above, other factors affect streaming media quality besides buffering. A need exists to assist users with all aspects affecting the quality of streaming media, such as selecting the media type and the fastest reliable data rate for the available download speed.

### SUMMARY OF THE INVENTION

The invention described in detail below comprises a computer implemented process for optimizing a media environment having a media player and a data stream, the process comprising: configuring a performance criterion; receiving the data stream; collecting performance data from the data stream; analyzing the performance data to determine if the performance data satisfies the performance criterion; and if the performance data does not satisfy the performance criterion, identifying an alternate media environment that provides improved performance data, and changing to the alternate media environment for improved performance.

### BRIEF DESCRIPTION OF DRAWINGS

The novel features believed characteristic of the invention are set forth in the appended claims. The invention itself, however, as well as a preferred mode of use, further objectives and advantages thereof, will be understood best by references to the following detailed description of an illustrative embodiment when read in conjunction with the accompanying drawings, wherein:

FIG. 1 describes an exemplary client computer and content server attached to the interned.

FIG. 2 describes programs and files in memory on the client computer.

FIG. 3 describes the components of the SMO

FIG. 4 is a flow chart of the Configuration Component (CC).

FIG. 5 is a flow chart of the Data Collection Component (DC).

FIG. 6 is a flow chart of the Analysis Component (AC).

FIG. 7 is a flow chart of the Response Component (RC).

FIG. 8 is a flow chart of the Display Interface (DI).

### DETAILED DESCRIPTION OF THE PREFERRED EMBODIMENT

The principles of the present invention are applicable to a variety of computer hardware and software configurations. The term “computer hardware” or “hardware,” as used herein, refers to any machine or apparatus that is capable of accepting, performing login operations on, storing, or displaying data, and includes without limitation processors and memory; the term “computer software” or “software,” refers to any set of instructions operable to cause computer hardware to perform an operation. The term “computer,” as used herein, includes without limitation any useful combination of hardware and software, and a “computer program” or “program” includes without limitation any software operable to cause computer hardware to accept, perform logic operations on, store or display data. A computer program may, and often is, comprised of a plurality of smaller programming units, including without limitation subroutines, modules, functions, methods and procedures. Thus, the functions of the present invention may be distributed among a plurality of computers and computer programs. The invention is described best, though, as a single computer program that configures and enables one or more general purpose computers to implement the novel aspects of the invention. For illustrative purposes, the inventive computer program will be referred to as the “Streaming Media Optimizer” or “SMO ”

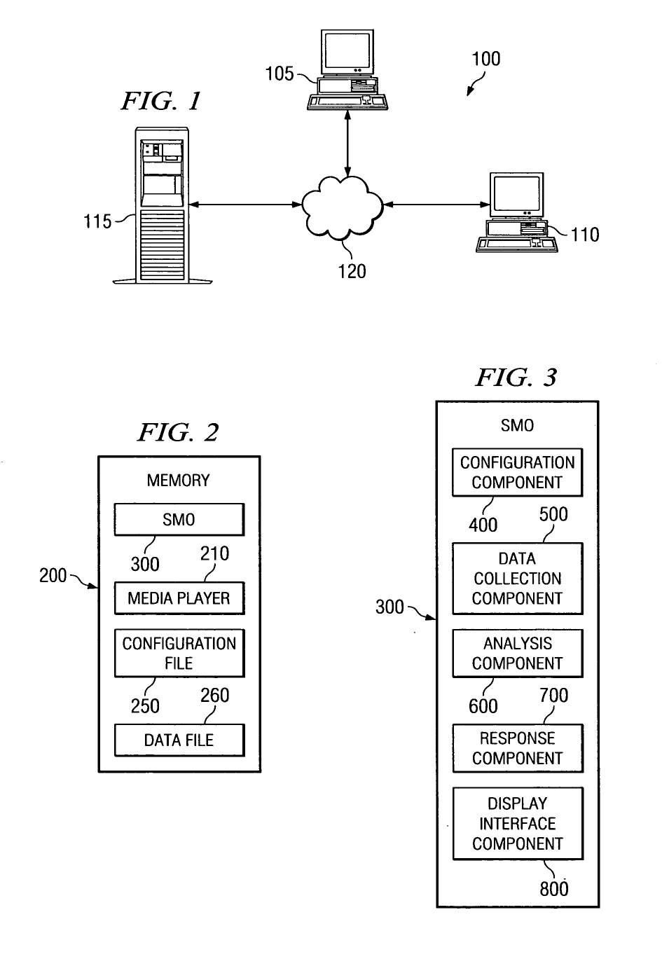

Additionally, the SMO is described below with references to an exemplary network of hardware devices, as depicted in FIG. 1. The term “network,” as used herein, comprises any number of hardware devices coupled to and in communication with each other through a communications medium, such as the Internet. The term “communications medium,” as used herein, includes without limitation any physical, optical, electromagnetic, or other medium through which hardware or software can transmit data. The network could be, for example, a closed corporate network, such as a LAN or WAN, or the network could include clients and servers on the World Wide Web. For descriptive purposes only, exemplary network 100 has only a limited number of nodes, including client computers 105 and 110, web server 115 and internet connection 120. internet connection 120 comprises all hardware, software and communications media necessary to enable communication between network notes 105-115. Unless otherwise indicated below, all network nodes use publicly available protocols or messaging services to communicate with each other through internet connection 120.

SMO 300 typically is located in a memory, represented schematically as memory 200 in FIG. 2. The term “memory,” as used herein, includes without limitation any volatile or persistent medium, such as an electrical circuit, magnetic disk, or optical disk, in which a computer can store data or software for any duration. A single memory may encompass and be distributed across a plurality of media. Thus, FIG. 2 is included merely as a descriptive expedient and does not necessarily reflect any particular physical embodiment of memory 200. As depicted in FIG. 2, though, memory 200 may include additional data and programs. Of particular import to SMO 300, memory 200 also may include media player 210, configuration file 250 and data file 260. Media player 210 represents any hardware or software capable of receiving streaming data, particularly streaming media data. Examples of popular contemporary media players include the WINDOWS Media Player by MICROSOFT, the QUICKTIME player by Apple Computer, Inc., and the REALPLAYER by RealNetworks, Inc. Collectively, a media player, such as media player 210, and a data stream are referred to herein as a “media environment.” As those skilled in the art should understand, many media players also are available as a plug-in component to an internet browser program. Similarly, in alternative embodiments SMO 300 may be a stand-alone application, a plug-in to a media player, or a plug-in to an internet browser. Configuration file 250 contains certain default values relating to how SMO 300 collects data, analyzes the data and responds to the analysis. Configuration file 250 can be modified by the user. Data file 260 stores collected data as proscribed by configuration file 250.

SMO 300 comprises five components as shown in FIG. 3: Configuration Component 400 (CC), Data Collection Component 500 (DC), Analysis Component 600 (AC), Response Component 700 (RC) and Display Interface 800 (DI). Except for DI 800 and user prompts, SMO 300 runs in the background and is transparent to users. Although SMO 300 and its components may reside in any suitable memory found in network 100, SMO 300 and its components generally operate on a client computer, such as client computer 105.

Referring to FIG. 4 for illustration, CC 400 starts (410) when SMO 300 is activated. CC 400 scans the client computer to determine what media players are available (412), and stores the list in the configuration file 250 (414). CC 400 also stores one or more performance criteria in configuration file 250. At any time, the user may change performance criteria (416). Changes may be made, for example, by selecting a SMO configuration option from the “tools” menu on an internet browser 210 or by opening DI 800 and selecting a “settings” radio button. If the user chooses to set performance criteria, DI 800 provides a menu or screen with various configurable criteria, prompting the user to choose various performance criteria (418). User selected performance criteria include but are not limited to: setting a low limit data rate that requires a response; setting a packet loss rate that requires a response; selecting other criteria to use in quality determinations such as video index quality; and whether SMO 300 should automatically change streams or media players or should prompt the user before making changes. All changes to the default performance criteria are saved in configuration file 360 (420). Whenever CC 400 detects a new active media stream (422), CC 400 starts DC 500 (424). CC 400 then determines if alternate media streams are available from the content provider server (426). If alternate media streams are available, CC 400 starts DC 500 for the alternate streams (428). CC 400 determines whether browser 210 is still open (430). As long as the browser is open, CC 400 allows users to set performance criteria and watches for new active media streams. When the browser closes, CC 400 ends (432).

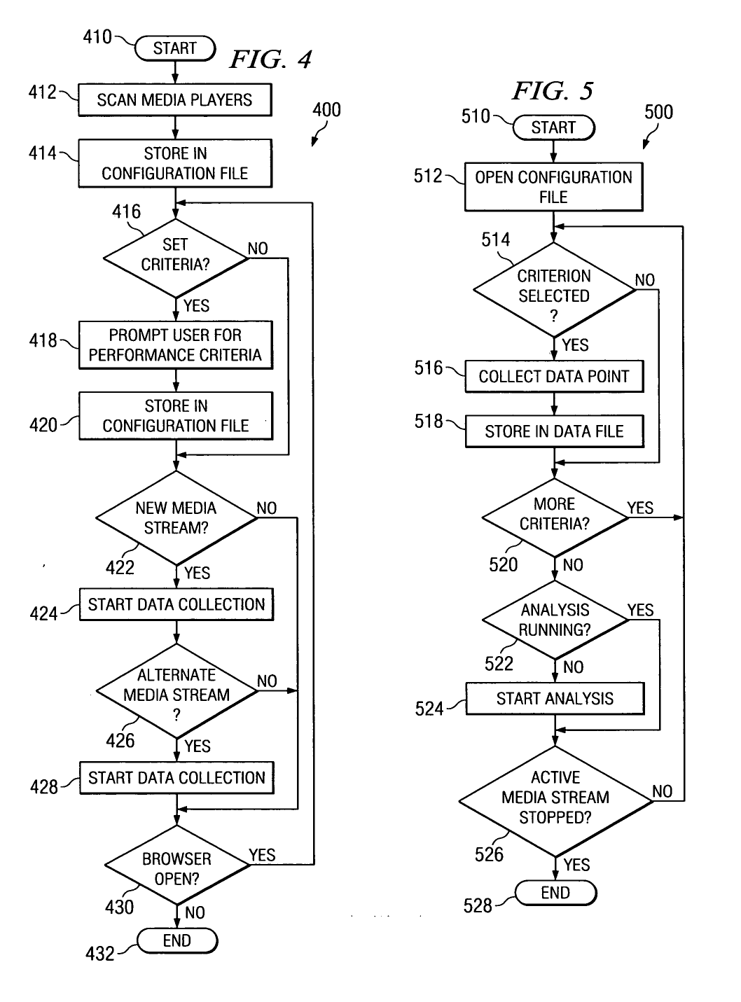

DC 500 starts (510) when called by CC 400, as shown in FIG. 5. DC 500 opens configuration file 250 (512) and identifies the first performance criterion (514). DC 500 collects a sample of performance data for the performance criteria (516) and stores it in data file 260 (518).

For example, if configuration file 250 indicates that the data rate should be used as performance criterion, DC 500 records the data rate in data file 260. If another criterion, such as video index quality, is listed in configuration file 250 (520), DC 500 repeats the steps of taking data points and storing the data points in data file 260 (516-518). Once performance data is collected for every criterion specified in configuration file 250, DC 500 determines if AC 600 is running (522), and starts AC 600 if it is not (524). Once AC 600 is running, DC 500 determines if the media stream is still active (526). If the stream is still active, DC 500 continues collecting performance data (514-520); otherwise it ends (528). DC 500 collects performance data for each available media stream in the same manner, until the active media stream stops.

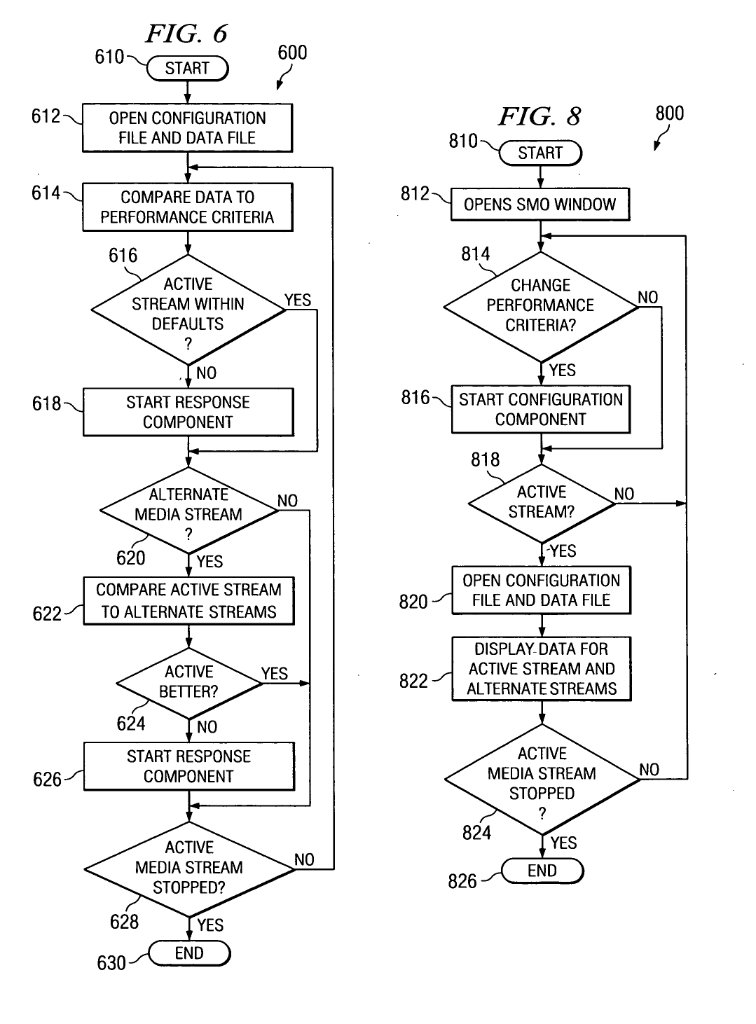

As shown in FIG. 6, AC 600 starts (610) when called by DC 500. In general, AC 600 compares the performance of the active media environment (i.e. the active media player and the active media stream) to the performance criteria set in configuration file 250, and attempts to identify alternate media environments that improve performance if the active media environment does not satisfy the performance criteria. More particularly, AC 600 first opens both the configuration file 250 and the data file 260 (612). AC 600 then compares the data from the active media stream to the performance criteria in configuration file 250 (614). If the active media stream fails or otherwise does not satisfy the performance criteria in configuration file 250, AC 600 starts RC 700 (610). If the active media stream meets or exceeds the performance criteria, AC 600 determines if one or more alternate media streams are available (618). If another media stream is available, AC 600 compares data from the alternate media stream to data from the active media stream (620). If the active media stream performance is not better than the alternate media stream performance, AC 600 starts RC 700 (622). If the active media stream is performing better than the alternate media stream, then AC 600 determines if the active media stream has stopped (624). AC 600 continues to compare the active media stream to the performance criteria specified in configuration file 250, and to alternate media streams until the active media stream stops (614-624). When the active media stream stops, AC 600 ends (626).

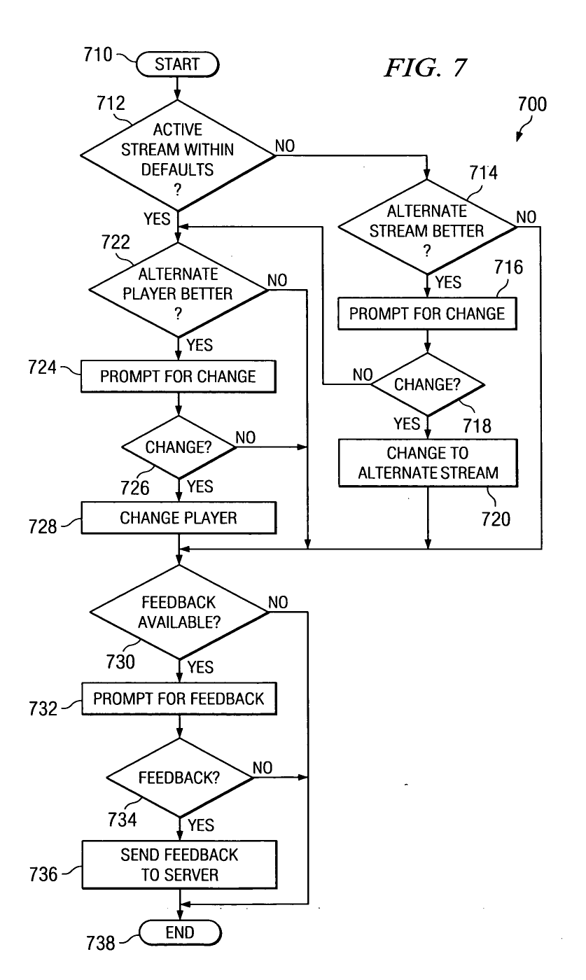

RC 700 starts (710) when called by the AC 600, as shown in FIG. 7. RC 700 first determines if it was called because the active media stream did not meet the performance criteria in configuration file 250 (712). If the active media stream failed or did not meet the performance criteria, RC 700 determines if an alternate media stream is performing better (714). If an alternate media stream is performing better, RC 700 prompts the user to change to the alternate media stream (716). If the user wants to change to the alternate media stream (718), or if the configuration file is set to allow automatic changes, RC 700 changes the active media stream to the alternate media stream (720). If no change is made, or if the active media stream meets the default performance criteria, RC 700 determines if an alternate media player would perform better with the active media stream (722). If an alternate player would perform better, RC 700 prompts the user to change players (724). If the user wants to change players (726), or if the configuration file is set to allow automatic changes, RC 700 will change to the alternate player (728). After the change options are exercised, or if there is not an alternate player or stream, RC 700 determines if the content provider provides a mechanism for feedback from users (730). If feedback is available, RC 700 prompts the user to determine if feedback to the content provider is desired (732). If the user wants to provide feedback (734), or if the configuration file is set to allow automatic feedback, RC 700 will send feedback regarding the problems encountered with the media stream (736). The feedback mechanism could include, but is not limited to, e-mail or instant message. RC 700 ends (738) if feedback is not available, or after feedback is sent or the user decides not to send feedback.

As shown in FIG. 8, DI 800 starts (810) whenever a user opens DI 800 or whenever an active media stream is started. DI 800 provides a window (812), which has, for example, buttons or menus that allow a user to change performance criteria. If a user wants to change performance criteria (814), CC 400 is started (816). If the user does nothing, DI 800 determines if an active media stream is available. If an active media stream is detected (818), DI 800 opens configuration file 250 and data file 260 (820) and displays the data (822), as designated by configuration file 250, from the active media stream and any other available media stream. The data may be displayed, for example, in a table or graph. As long as the active media stream has not stopped (824), DI 800 continues to allow configuration changes and update the display with data from the active media stream and alternate media streams (814-824). DI 800 ends when the active media stream stops (826). One skilled in the art would understand DI 800 may provide menus or buttons enabling the user to perform other functions not shown in the drawings. These functions may include, as examples, the ability to compare media player performance from a given media stream and the ability to change media streams or players using DI 800, even when AC 600 does not recommend a change. DI 800 also could remain open after the media stream stops, and end only when shut down by the user.

A preferred form of the invention has been shown in the drawings and described above, but variations in the preferred form will be apparent to those skilled in the art. The preceding description is for illustrative purposes only, and the invention should not be construed as limited to the specific form shown and described. The scope of the invention should be limited only by the language of the following claims.

What is claimed is:

1. A computer implemented process for optimizing a media environment having a media player and a data stream, the process comprising:
configuring a performance criterion;
receiving the data stream;
collecting performance data from the data stream;
analyzing the performance data to determine if the performance data satisfies the performance criterion; and
if the performance data does not satisfy the performance criterion,
identifying an alternate media environment that provides improved performance data, and
changing to the alternate media environment for improved performance.

2. The computer implemented process of claim 1 wherein the alternate media environment comprises an alternate data stream.

3. The computer implemented process of claim 1 wherein the alternate media environment comprises an alternate media player.

4. The computer implemented process of claim 1 further comprising displaying a prompt to receive user input before changing to the alternate media environment.

5. The computer implemented process of claim 1 wherein the performance criterion is a data rate.

6. The computer implemented process of claim 1 wherein the performance criterion is a video quality metric.

7. The computer implemented process of claim 1 wherein the performance criterion is an audio quality metric.

8. The computer implemented process of claim 1 wherein the performance criterion comprises a packet loss rate.

9. An apparatus for optimizing a media environment having a media player and a data stream, the apparatus comprising:
a processor;
a memory connected to the processor;
a performance criterion stored in the memory; and
a streaming media optimizer program in the memory operable to cause the processor to receive the data stream,
collect performance data from the data stream,
analyze the performance data to determine if the performance data satisfies the performance criterion, and
if the performance data does not satisfy the performance criterion, identify an alternate media environment that provides improved performance data, and change to the alternate media environment to improve performance.

10. The apparatus of claim 9 wherein the alternate media environment comprises an alternate data stream.

11. The apparatus of claim 9 wherein the alternate media environment comprises an alternate media player.

12. The apparatus of claim 9 further comprising an output device connected to the processor; and wherein the streaming media optimizer program further causes the processor to display a prompt to receive user input before changing to the alternate media environment.

13. The apparatus of claim 9 wherein the performance criterion is a data rate.

14. The apparatus of claim 9 wherein the performance criterion is a video quality metric.

15. The apparatus of claim 9 wherein the performance criterion is an audio quality metric.

16. The apparatus of claim 9 wherein the performance criterion is a packet loss rate.

17. A computer-readable memory having a computer program for performing a method of optimizing a media environment having a media player and a data stream, the method comprising:
configuring a performance criterion;
receiving the data stream;
collecting performance data from the data stream;
analyzing the performance data to determine if the performance data satisfies the performance criterion; and
if the performance data does not satisfy the performance criterion,
identifying an alternate media environment that provides improved performance data, and
changing to the alternate media environment for improved performance.

18. The computer-readable memory of claim 17 wherein the alternate media environment comprises an alternate data stream.

19. The computer-readable memory of claim 17 wherein the alternate media environment comprises an alternate media player.

20. The computer-readable memory of claim 17 further comprising displaying a prompt to receive user input before changing to the alternate media environment.
